(19) United States
(12) Patent Application Publication
(10) Pub. No.: US 2005/0070243 A1
(43) Pub. Date: Mar. 31, 2005

(54) Multichannel echo canceller system using active audio matrix coefficients

(76) Inventors: Daniel Willem Elisabeth Schobben, Eindhoven (NL); Gerardus Paul Maria Egelmeers, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,420

(22) PCT Filed: Dec. 9, 2002
(86) PCT No.: PCT/IB02/05271

(30) Foreign Application Priority Data
Jan. 17, 2002 (EP) 02075198.8

(51) Int. Cl. H04B 1/10

(52) U.S. Cl. 455/299

(57) ABSTRACT

An echo canceller system is described, which comprises an audio matrix decoder coupled to audio inputs for providing multiple audio output signals, and a multi-channel echo canceller coupled to the audio inputs. The echo canceller system further comprises audio receiving means for receiving a mixture of the audio output signals and a wanted signal. The multi-channel echo canceller is coupled to the audio matrix decoder for using the audio matrix coefficients with multi-channel echo cancellation for deriving the wanted signal from the mixture. The computational and audio processing complexity of such a system is reduced.

The present invention relates to an echo canceller system, comprising an audio matrix decoder coupled to audio inputs for providing multiple audio output signals, and a multi-channel echo canceller coupled to the audio inputs.

The present invention also relates to a multi-channel audio system, for example a Hi-Fi set, a car audio system or a television or teleconferencing system and to a communication system, such as a mobile or hands free communication system, in particular a telephone system, or car telephone system, which aforementioned systems may be voice controlled and comprise such an echo canceller. The invention also relates to signals for use in the echo canceller.

Such an echo canceller system is known from WO 98/42162. The known echo canceller system comprises an audio matrix decoder, such as an active audio surround decoder providing multiple audio surround output signals in a multi-channel arrangement having for example three or five loudspeakers. The loudspeakers may e.g. be positioned in a home theatre, a personal computer “multimedia” environment and/or combined with a television set. The effects of echoes may be included in a transfer function matrix acting as a multi-channel echo canceller. The known echo canceller system does however not disclose an efficient way of achieving multi-channel echo cancelling.

It is an object of the present invention to provide an improved echo canceller system posing a reduced audio signal processing burden on multi-channel echo cancelling, and which may also be equipped with voice control features.

Thereto the echo canceller system according to the invention is characterized in that the echo canceller system further comprises audio receiving means for receiving a mixture of the audio output signals and a wanted signal, and that the multi-channel echo canceller is coupled to the audio matrix decoder for using the audio matrix coefficients with multi-channel echo cancellation for deriving the wanted signal from the mixture.

It is an advantage of the echo canceller system according to the present invention that by using the audio matrix coefficients present in the audio matrix decoder or derivable possibly only from its decoder output signals, multi-channel echo cancelling can be effected very effectively, without high computational and/or signal processing complexity.

In addition voice control capabilities are improved, because the echo canceller system according to the invention is capable of deriving a wanted signal, such as a voice signal from the mixture of sound, echoes and voice present in a room. This extends the cost effective application possibilities of the echo system according to the invention in more and more accepted voice controlled systems, such as multi-channel communication, audio and/or television systems, Hi-Fi sets, car audio systems and teleconferencing systems.

An embodiment of the echo canceller system according to the invention is characterized in that the echo canceller system comprises an active matrix tracker coupled to both the audio inputs and matrix decoder outputs for deriving the audio matrix coefficients therefrom.

In general the active audio matrix coefficients are only available on chip in the audio matrix decoder and not externally available, in particular not in audio systems which are already on the market or installed at a customer premises. The active matrix tracker provides an easy to apply alternative to a full exchange of such a chip, because it simply derives the matrix coefficients from the audio input and output signals of the matrix decoder, which signals are already externally available. Thus the active matrix tracker can easily be added to known echo canceller systems.

A further embodiment of the echo canceller system according to the invention is characterized in that the multi-channel echo canceller calculates a number of filter functions which is smaller than the number of the multiple audio output signals.

Advantageously no separate echo cancelling calculations are needed for all multiple audio output signals, which reduces the computational complexity of the multi-channel echo cancelling even further.

A still further embodiment of the echo canceller system according to the invention is characterized in that the filter functions calculations are based on filter update contributions which take account of at least some of the audio output signals.

Despite the reduction of the computational complexity of the audio cancelling filter function calculation, the quality of the echo cancelled output signals is not effected, because the filter updates take account of some and possibly all of the multiple audio output signals.

Another embodiment of the echo canceller system according to the invention is characterized in that the echo canceller comprises a speech detector coupled to reducing the number of independent multiple output signals once speech is detected.

It is an advantage that if speech is detected by the speech detector echo cancelling can be simplified at the expense of only a small loss of audio quality, which will however not be noticeable because a listener is then giving commands by his speech. At present the echo canceller system according to the invention will be elucidated further together with its additional advantages, while reference is being made to the appended drawing, wherein similar components are being referred to by means of the same reference numerals.

In the drawings:

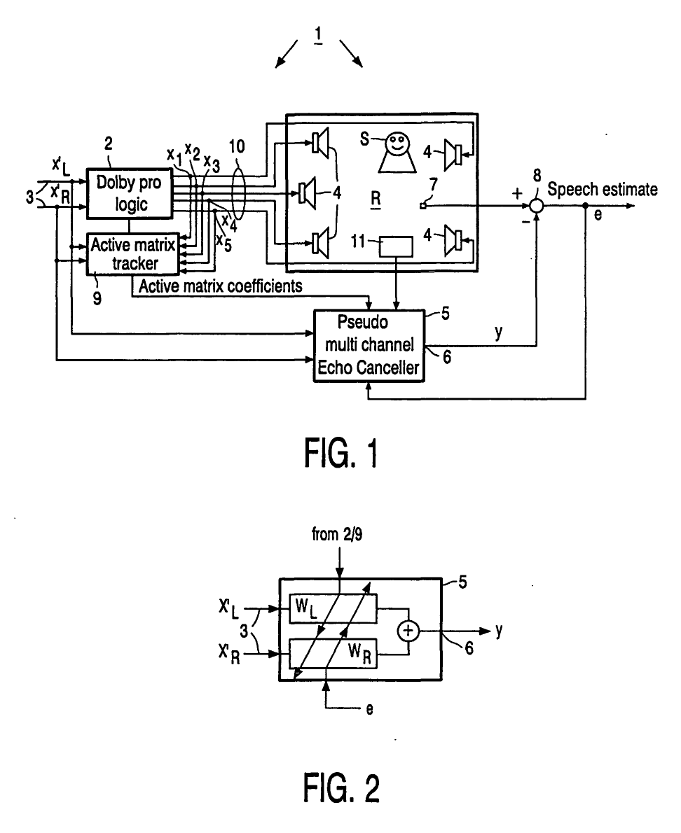

FIG. 1 shows a schematic view of combined possible embodiments of the echo canceller system according to the invention; and

FIG. 2 shows a detailed embodiment of the echo canceller for application in the echo canceller system of FIG. 1.

FIG. 1 shows an echo canceller system 1, comprising an audio matrix decoder 2, for example a Dolby Pro Logic I/II, Circle Surround system, or the like. The audio matrix decoder 2 as shown is coupled to audio inputs 3 carrying two channels, in this case left and right stereo signals x′_{L} and x′_{R} respectively. Here five multiple audio signals x₁, x₂, x₃, x₄ and x₅ are derived from the stereo signals by the decoder 2 and supplied to five loudspeakers generally designated 4, in a room R. The system 1 also comprises a multi-channel echo canceller 5 coupled to the audio inputs 3. The echo canceller 5 provides an echo cancelling signal y at its output 6. Audio receiving means 7 generally embodied by one or more microphones are placed in the room R for receiving a mixture of the five audio output signals and a wanted speech signal originating from a listener/speaker S in the room R. A subtracter 8 is coupled to both the microphone 7 and the echo canceller output 6 for providing an accurate estimate of the wanted speech signal e. Such a speech signal e may be used and included in any system for providing voice controlling commands. Examples of voice control systems possibly implementing those commands are a Hi-Fi set, a car audio system, a television. Examples of communications systems are a teleconferencing system, a mobile or hands free communication system, in particular a telephone system, car telephone system and the like.

The relation between input signals and output signals of the matrix decoder 2 can be written in vector notation as:
X=A(αᵢ; βᵢ)X′ (1)
where the vector X represents the five audio signals xᵢ with i=1 . . . 5, the vector X′ represents the stereo input signals xⱼ with j=L, R and A(αᵢ; βᵢ) represents a 2×5 coefficient matrix having ten coefficients. The multi-channel echo canceller 5 is coupled to the audio matrix decoder 2, where these coefficients are used by the echo canceller in a manner to be explained hereafter for deriving the wanted signal from the mixture of signals received by the receiving microphone 7.

In an alternative embodiment also shown in FIG. 1 the echo canceller system 1 comprises an active matrix tracker 9 coupled to both the audio inputs 3 and matrix decoder outputs 10 for deriving the ten audio matrix coefficients of the matrix A(αᵢ; βᵢ) (having 5 coefficients αᵢ in its first column and 5 coefficients βᵢ in its second column) therefrom, in accordance with equation (1). The tracker 9 may be included in the matrix decoder 2 or simply added later thereto. It is also possible that the tracker 9 is only coupled to the decoder output 10 (and thus indirectly coupled to its input), which tracker 9 is then capable of deriving the decoder coefficients from the decoder output signals alone. This is advantageous in case the decoder inputs 3 and/or the matrix coefficients are not—easily externally—available. In the alternative embodiment mentioned before the active matrix tracker 9 is coupled to the echo canceller 5 where again these coefficients are used by the echo canceller for deriving the wanted signal from the mixture of signals received by the receiving microphone 7.

A straightforward approach to the problem of cancelling the echoes arising between the five loudspeakers 4 and the microphone 7 would be to couple the five decoder outputs 10 to the echo canceller 5. The canceller 5 then would have to implement a five channel adaptive filter requiring a high computational complexity. Apart therefrom additional problems arise involving the uniqueness of the solutions which the adaptive filters are capable of finding. FIG. 1 shows that the echo canceller 5 is directly coupled to the audio input 3, and that use is made of the ten active matrix coefficients (αᵢ; βᵢ) made available for echo cancelling.

As suggested by the representation of FIG. 2 the multi-channel echo canceller 5 calculates a number of filter transfer functions with is less than the number of the multiple audio output signals. The five transfer functions between the loudspeakers 4 and the microphone 7 may in particular be represented by only two filter transfer functions w_{L} and w_{R}. This reduces the computational complexity of the echo canceller 5. These transfer functions may be updated by updates Δ_{L} and Δ_{R} such that the added echo canceller output signal y represents the microphone signal exclusive the wanted speech signal as accurate as possible, according to:
w_{L}=w′_{L}+Δ_{L}
w_{R}=w′_{R}+Δ_{R}
where the ′ denoted the previous value. Bookkeeping may involve the distribution of the updates over all five transfer filters, which may be according to:
wᵢ=w′ᵢ+αᵢ(/Σ|αᵢ|)Δ_{L}+βᵢ(/Σ|βᵢ|)Δ_{R} for i=1, 2, . . . 5.
Where the sigma represents a summation over i, and where αᵢ and βᵢ are the coefficients of the matrix A. The relation between the filters is now given by:
w_{L}=Σ(αᵢwᵢ)
w_{R}=Σ(βᵢwᵢ)
In this case all five acoustical paths are tracked, which is advantageous in case the active matrix changes in time. When convergence is achieved, the active matrix may suddenly change and the correct filters are obtained immediately by latter equations.

In some applications for example involving Pro-Logic, or Pro-Logic 2 decoders some of the five filters may be joined to reduce the burden of the necessary amount of calculations. When mono surround is used for example, both acoustical paths associated with surround are tracked using only one filter. In case of possible singularities or numerical overflows in the echo cancelling calculations the five channels may be mapped into lesser channels in order to resolve these kinds of errors. It is also possible to down mix multi-channel audio to stereo when speech activity is detected by a speech detector 11 to be coupled to the echo canceller 5. This advantageously allows the application of a much simpler echo canceller at only a small temporarily loss of sound quality.

Stated simple the audio matrix decoder 2 may derive a number of output signals from its input, which number exceeds the number of input signals. The decoder 2 may comprise one or more filters, for example controllable filters, whose filter operation and filter function depends on control signals. These control signals may for example be included in the music.

Whilst the above has been described with reference to essentially preferred embodiments and best possible modes it will be understood that these embodiments are by no means to be construed as limiting examples of the system concerned, because various modifications, features and combinations of features falling within the scope of the appended claims are now within reach of the skilled person.

1. Echo canceller system (1), comprising an audio matrix decoder (2) coupled to audio inputs (3) for providing multiple audio output signals (x₁ . . . x₅), and a multi-channel echo canceller (5) coupled to the audio inputs (3), characterized in that the echo canceller system (1) further comprises audio receiving means (7) for receiving a mixture of the audio output signals (x₁ . . . x₅) and a wanted signal (e), and that the multi-channel echo canceller (5) is coupled to the audio matrix decoder (2) for using the audio matrix coefficients with multi-channel echo cancellation for deriving the wanted signal (e) from the mixture.

2. Echo canceller system (1) according to claim 1, characterized in that the echo canceller system (1) comprises an active matrix tracker (9) coupled to both the audio inputs (3) and matrix decoder outputs (10) for deriving the audio matrix coefficients therefrom.

3. Echo canceller system (1) according to claim 1, characterized in that the multi-channel echo canceller (5) calculates a number of filter functions with is less than the number of the multiple audio output signals (x₁ . . . x₅).

4. Echo canceller system (1) according to claim 3, characterized in that the filter functions calculations are based on filter update contributions which take account of at least some of the audio output signals (x₁ . . . x₅).

5. Echo canceller system (1) according to claim 1, characterized in that the echo canceller (5) comprises a speech detector (11) coupled to reducing the number of independent multiple output signals (x₁ . . . x₅) once speech is detected.

6. Multi-channel audio system, for example a Hi-Fi set, a car audio system or a television or teleconferencing system, comprising an echo canceller system (1) according to claim 1, the echo canceller system (1) comprising an audio matrix decoder (2) coupled to audio inputs (3) for providing multiple audio output signals (x₁ . . . x₅), and a multi-channel echo canceller (5) coupled to the audio inputs (3), characterized in that the echo canceller system (1) further comprises audio receiving means (7) for receiving a mixture of the audio output signals (x₁ . . . x₅) and a wanted signal (e), and that the multi-channel echo canceller (5) is coupled to the audio matrix decoder (2) for using the audio matrix coefficients with multi-channel echo cancellation for deriving the wanted signal (e) from the mixture.

7. Communication system, such as a mobile or hands free communication system, in particular a telephone system, car telephone system, comprising an echo canceller system (1) according to claim 1, the echo canceller system (1) comprising an audio matrix decoder (2) coupled to audio inputs (3) for providing multiple audio output signals (x₁ . . . x₅), and a multi-channel echo canceller (5) coupled to the audio inputs (3), characterized in that the echo canceller system (1) further comprises audio receiving means (7) for receiving a mixture of the audio output signals (x₁ . . . x₅) and a wanted signal (e), and that the multi-channel echo canceller (5) is coupled to the audio matrix decoder (2) for using the audio matrix coefficients with multi-channel echo cancellation for deriving the wanted signal (e) from the mixture.

8. Signals for use in the echo canceller system (1) according to claim 1, the echo canceller system (1) comprising an audio matrix decoder (2) coupled to audio inputs (3) for providing multiple audio output signals (x₁ . . . x₅), and a multi-channel echo canceller (5) coupled to the audio inputs (3), characterized in that the echo canceller system (1) further comprises audio receiving means (7) for receiving a mixture of the audio output signals (x₁ . . . x₅) and a wanted signal (e), and that the multi-channel echo canceller (5) is coupled to the audio matrix decoder (2) for using the audio matrix coefficients with multi-channel echo cancellation for deriving the wanted signal (e) from the mixture.
